(19) United States
(12) Patent Application Publication
(10) Pub. No.: US 2024/0380769 A1
(43) Pub. Date: Nov. 14, 2024

(54) METHODS AND SYSTEMS FOR ASSESSING AND ENHANCING CYBERSECURITY OF A NETWORK

(71) Applicant: WILLOWGLEN SYSTEMS INC., Edmonton (CA)

(72) Inventors: Ian VERHAPPEN, Calgary (CA); Scott GRIEG, Edmonton (CA)

(21) Appl. No.: 18/692,716

(22) PCT Filed: Sep. 16, 2022
(86) PCT No.: PCT/CA22/51380

§ 371 Date: Mar. 15, 2024

Related U.S. Application Data
(60) Provisional application No. 63/245,621, filed on Sep. 17, 2021.

(51) Int. Cl. H04L 9/40

(52) U.S. Cl. CPC H04L 63/1425; H04L 63/1416

(57) ABSTRACT

A method and related system are provided for assessment of cybersecurity of a network, by determining cybersecurity threat scores on a node-by-node basis, based on network information associated with the node, acquired by network monitoring. Another method and related system are provided for control of a response of a network to a data packet addressed from a first node to a second node in the network depending on the node locations, and/or cybersecurity threat scores of the nodes. Another method and related system are provided for maintaining a network to reduce cybersecurity risks by monitoring network components for cybersecurity vulnerabilities, generating and transmitting a first notification to a first node to take a corrective maintenance action to address the vulnerabilities within a time period, and escalating the notification to a second node of the network if the corrective action is not taken within the time period.

### CROSS-REFERENCE TO RELATED APPLICATION

This application claims priority to and the benefit of U.S. provisional patent application No. 63/245,621, filed on Sep. 17, 2021, the entire contents of which are incorporated by reference in this application, where permitted.

### FIELD OF THE INVENTION

The present application relates to assessing and enhancing cybersecurity of a network of components, such as components of a SCADA system.

### BACKGROUND OF THE INVENTION

FIG. 1 is a schematic depiction of an embodiment of a SCADA (supervisory control and data acquisition) system 100, which is conceptualized by a hierarchy of levels, each having one or more nodes—i.e., computers or other electronic devices. Level 1 nodes include field level electromechanical devices used in process control and instrumentation, with non-limiting examples including pumps, valves, actuators, sensors, and other components as known in the art. Level 2 nodes include processors and input/output modules for control of and data acquisition from Level 1 nodes, with non-limiting examples including programmable logic controllers (PLCs) and remote terminal units (RTUs). Level 3 nodes through level ‘n’ nodes include supervisory and control computers. Such computers may provide a machine-to-human interface such as graphical user interfaces. Nodes of the SCADA system communicate with each other via a communications network, as implemented by wired and/or wireless data connections denoted by the bi-directional arrow lines in FIG. 1.

Nodes of the SCADA system may be provisioned with “off-the-shelf” processors, operating systems, and other devices configured for end-to-end digital data packet communication protocols such as Ethernet and Internet Protocol Suite. Although this simplifies connectivity of the nodes, this can also make all levels of the SCADA system susceptible to a single “attack vector” (i.e., a path, method, or event that is exploited to access the SCADA system). In particular, the vulnerability of Level 1 and 2 nodes in a SCADA system to cyberattacks poses a safety hazard, because unauthorized use of or disruption to these nodes can affect industrial processes.

There remains a need in the art for technologies to assess and enhance the cybersecurity of a network of components, such as components of a SCADA system. It would be desirable if such technologies were able to assess the cybersecurity of individual nodes of the network, as well as the network as a whole. It would be desirable if such technologies were able to control the network in response to data transmissions between nodes, depending on the location of nodes within the topology of the network and cybersecurity threats associated with the nodes. It would be desirable if such technologies were able to prompt maintenance of the network to reduce vulnerabilities of the network to cybersecurity risks.

### SUMMARY OF THE INVENTION

In a first aspect, the present invention includes a method for assessing a cybersecurity threat associated with a node in a network. The method comprises the steps of:
(a) storing in a memory, at least one rule for determining at least one cybersecurity threat score for the node, wherein each of the at least one rule is based on network information associated with the node comprising one or a combination of:
   (i) a volume or a pattern of data packet traffic transmitted or received by the node;
   (ii) a size, a content, or a communication protocol of a data packet transmitted to or received by the node:
   (iii) a network address of the node;
   (iv) a connection relationship of the node to another node in the network:
   (v) an identifier or a role of a user of the node;
   (vi) an identifier of the node: or
   (vii) operational data indicative of an operational parameter of the node in a SCADA system;
(b) using a processor, monitoring the network to acquire the network information;
(c) using the processor, determining the at least one cybersecurity threat score for the node, based on the acquired network information and in accordance with the at least one rule; and
(d) using the processor, causing a display device to display the determined at least one cybersecurity threat score, a value derived from the determined at least one cybersecurity threat score, or an alert based on the determined at least one cybersecurity threat score.

The present invention also includes a computer-implemented system for performing the method of the first aspect. The system includes a processor, and a memory comprising a non-transitory computer-readable medium storing the at least one rule, and a set of instructions for executable by the processor to perform the steps of the method of the first aspect, and embodiments thereof, that are performed using the processor, as described above.

In a second aspect, the present invention includes a method for controlling a response of a network to a data packet addressed from a first node having a first node location to a second node having a second node location in the network. The method includes the steps of:
(a) using the processor, in accordance with at least one rule stored in a memory, determining an access control score based on the first node location and the second node location; and
(b) using the processor, controlling the response of the network comprising one or a combination of:
   (i) either allowing or preventing transmission of the data packet to the second node, depending on the determined access control score;
   (ii) varying a cybersecurity threat score for the second node based on the determined access control score: or
   (iii) causing a display device to display the determined access control score, a value derived from the determined access control score, or an alert based on the determined access control score.

In embodiments of the method of the second aspect, the processor may determine the first and second node locations from contents of the data packet.

In embodiments of the method of the second aspect, the access control score may be determined in accordance with the at least one rule based on whether the first and second node locations are within a same domain or a same zone of the network, and/or in accordance with the at least one rule based on whether the first node location is external to the network.

In embodiments of the method of the second aspect in which the response comprises preventing transmission of the data pack to the second node, the response may further comprise extracting data from the data packet, storing the data in a data buffer memory, and optionally storing a time stamp in the data buffer memory, wherein the time stamp is indicative of an attempted transmission time of the data packet form the first node to the second node.

In embodiments of the method of the second aspect, determining the access control score is further based on one or a combination of:
(i) a volume or a pattern of data packet traffic transmitted or received by the first node;
(ii) a size, a content, or a communication protocol of the data packet or another data packet transmitted to or received by the first node;
(iii) a network address of the first node;
(iv) a connection relationship of the first node to another node in the network;
(v) an identifier or a role of a user of the first node;
(vi) an identifier of the first node: or
(vii) operational data indicative of an operational parameter of the first node in a SCADA system.

The present invention also includes a computer-implemented system for performing the method of the second aspect. The system includes a processor, and a memory comprising a non-transitory computer-readable medium storing a set of instructions for executable by the processor to perform the steps of the method of the second aspect, and embodiments thereof, that are performed using the processor, as described above.

In a third aspect, the present invention includes a method for controlling a response of a network to a data packet addressed from a first node to a second node in the network. The method includes the steps of:
(a) storing in a memory, a rule for determining a cybersecurity threat score for the first node, wherein the rule is based on network information associated with the node comprising one or a combination of:
   (i) a volume or a pattern of data packet traffic transmitted or received by the first node;
   (ii) a size, a content, or a communication protocol of the data packet or another data packet transmitted to or received by the first node;
   (iii) a network address of the first node;
   (iv) a connection relationship of the first node to another node in the network;
   (v) an identifier or a role of a user of the first node;
   (vi) an identifier of the first node; or
   (vii) operational data indicative of an operational parameter of the first node in a SCADA system;
(b) using a processor, monitoring the network to acquire the network information;
(c) using the processor, determining the cybersecurity threat score for the first node, based on the acquired network information and in accordance with the rule; and
(d) using the processor, controlling the response of the network comprising one or a combination of:
   (i) either allowing or preventing transmission of the data packet to the second node, depending on the determined cybersecurity threat score;
   (ii) varying a cybersecurity threat score for the second node based on the determined cybersecurity threat score; or
   (iii) causing a display device to display the determined cybersecurity threat score, a value derived from the determined cybersecurity threat score, or an alert based on the determined cybersecurity threat score.

The present invention also includes a computer-implemented system for performing the method of the third aspect. The system includes a processor, and a memory comprising a non-transitory computer-readable medium storing the rule, and a set of instructions for executable by the processor to perform the steps of the method of the third aspect, and embodiments thereof, that are performed using the processor, as described above.

In a fourth aspect, the present invention includes a method for maintaining a network to reduce cybersecurity risks, the method performed by a processor and comprising the steps of:
(a) transmitting a first notification to a first node of the network to take a maintenance action for the network within a time period; and
(b) if the maintenance action is not taken within the time period, escalating the first notification, by transmitting a second notification to a second node of the network to take the maintenance action.

In embodiments of the method of the fourth aspect, the maintenance action may comprise one or a combination of installation of software, storing data to a memory, or removing or replacing a hardware or software component.

The present invention also includes a computer-implemented system for performing the method of the fourth aspect. The system includes a processor, and a memory comprising a non-transitory computer-readable medium storing a set of instructions for executable by the processor to perform the steps of the method of the fourth aspect, and embodiments thereof, that are performed using the processor, as described above.

In embodiments of the methods and systems of any of the aspects above, the nodes may be components of a SCADA system. The methods and systems of any two or more of the aspects above, or feature(s) thereof, may be implemented in combination with each other.

### BRIEF DESCRIPTION OF THE DRAWINGS

FIG. 1 is a schematic depiction of an embodiment of a SCADA system in the prior art to which the present invention may be applied.

FIG. 2 is a schematic depiction of an embodiment of a system of the present invention in relation to a SCADA system.

FIG. 3 is a functional block diagram of an embodiment of a system of the present invention.

FIG. 4 is an example of a security score matrix and a security threat vector computed by an embodiment of the method of the present invention.

FIG. 5 is an example of an embodiment of a report generated by an embodiment of the method of the present invention, showing a SCADA system with its nodes labelled with Security Threat Scores (STSs), and its data packet message paths labelled with Path Trust Scores (PTSs).

FIG. 6A is a schematic depiction of a set of conceptual masks overlaying the Security Score Matrix of FIG. 4, used in an embodiment of the method of the present invention.

FIG. 6B shows the security score matrix of FIG. 6A in isolation.

FIG. 6C shows the Object Class Mask of FIG. 6A in isolation.

FIG. 6D shows the Regulatory Control Mask of FIG. 6A in isolation.

FIG. 6E shows the Security Threat Mask Matrix of FIG. 6A in isolation.

FIG. 7 is an embodiment of a graphical user interface (GUI) element that is used to report cybersecurity information to a user of the system of the present invention.

### DETAILED DESCRIPTION OF EMBODIMENTS OF THE INVENTION

### Definitions

As used herein, the following terms shall have the following meanings.

“Memory” refers to a non-transitory tangible computer-readable medium for storing information in a format readable by a processor, and/or instructions readable by a processor to implement an algorithm. Despite use of the term in the singular, the term “memory” or “medium” includes a plurality of physically discrete, operatively connected devices such as in accordance with distributed computing techniques, cloud computing techniques, or microservice architecture of memories storing applications and databases. Non-limiting types of memory include solid-state, optical, and magnetic computer-readable media. Memory may be non-volatile or volatile. Instructions stored by a memory may be based on a plurality of programming languages known in the art, with non-limiting examples including the C, C++, Python™, MATLAB™, and Java™ programming languages.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), digital signal processors, integrated circuits, and field-programmable gate arrays (FPGAs).

“Node” refers to a computer or other electronic device that is operable to transmit and/or receive data and/or commands in a network. In embodiments, the node may be a component of a SCADA system such as a pump, valve, actuator, sensor, or processor such as in the form of programmable logic controller (PLC), or remote terminal unit (RTU), or other computer such as an operator workstation, or a portable computer such as a tablet computer, smartphone or a laptop computer.

“Network” refers to a set of nodes that are operatively connected for transmission of data and/or commands to each other via wired and/or wireless communication paths. In embodiments, the data and/or commands may be in the form of digital data packets, and communicated between nodes according to communication protocols such as Internet Protocol Suite, Ethernet, other local area network (LAN) protocols, and cellular standards, as known in the art. In embodiments, the network may be a SCADA system.

“Real-time” in describing an operation performed by a processor refers to the operation being performed with a level of responsiveness such that the operation output is substantially contemporaneous with the operation input. In embodiments, the time lapse between the operation input and the operation output may be less than 5 seconds, and preferably less than 1 second.

### System.

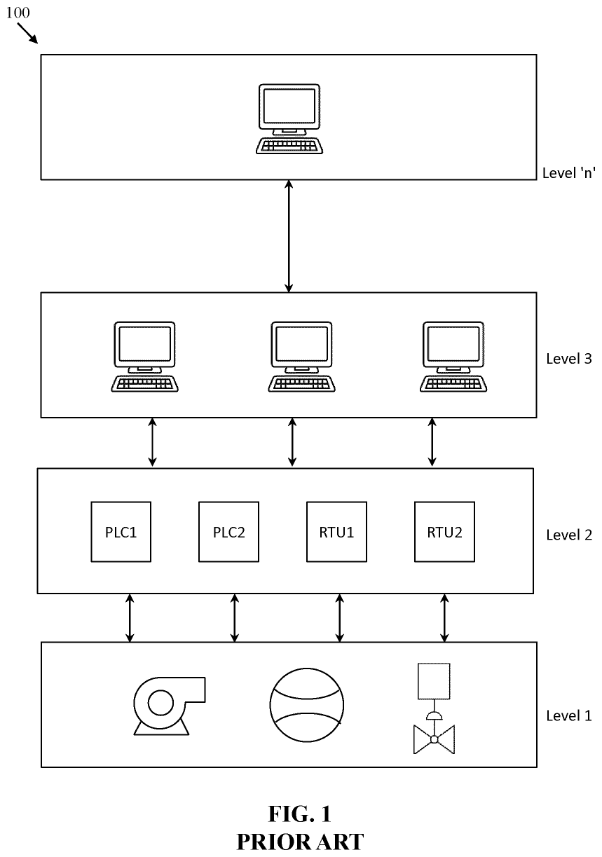

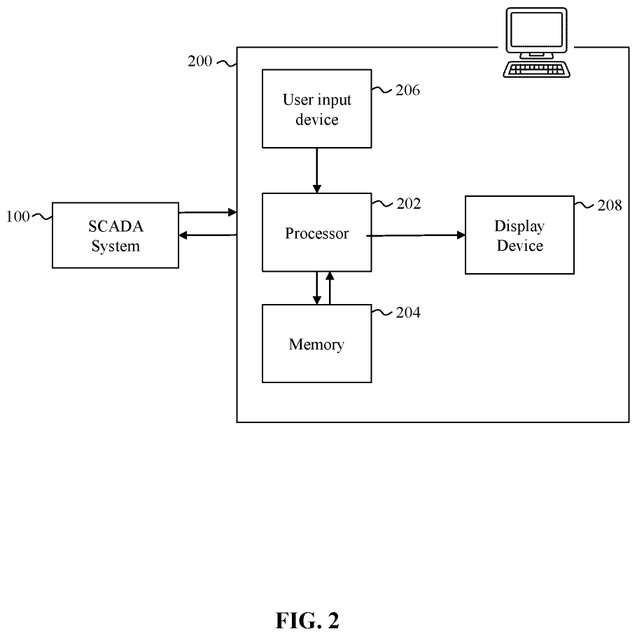

FIG. 2 is a schematic depiction of an embodiment of a system 200 of the present invention in relation to a network in the form of a SCADA system 100, such as shown in FIG. 1. In FIG. 2, arrow lines indicate operative connections between components, such as communication networks, wired connections and wireless connections for transfer of data, signals, and/or commands. In general, the system 200 includes a processor 202, a memory 204, a user input device 206, and a display device 208. Processor 202 and memory 204 may comprise one or a plurality of devices, which may be physically connected to each other or physically separated from each other, but operatively connected, such in accordance with distributed computing techniques, cloud computing techniques, and/or microservice architecture of memories storing applications and databases. User input device 206 may be a keyboard, mouse, touchscreen or other device permitting a human user to input commands to processor 202. Display device 208 may be one, or a plurality of a computer monitor(s) or touchscreen(s), or a combination of them. It will be understood that a power source is provided to power the components of the system 200 as necessary.

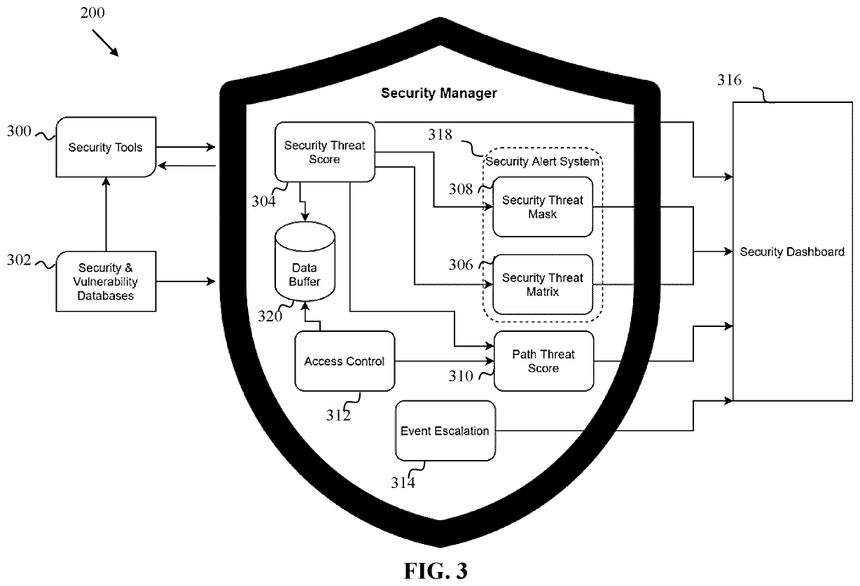

FIG. 3 is a functional block diagram of an embodiment of the system 200. The system 200 interacts with existing cybersecurity tools 300 and cybersecurity and vulnerability databases 302 that perform network monitoring functions—i.e., acquiring information regarding the use of, access to, and performance of a network that can be used to assess cybersecurity of the network. Network monitoring techniques, such as to acquire “network information associated with a node” (as defined below), by themselves, are known to persons skilled in that art of network management and security, data processing (including processing of digital data packets), network traffic measurement, network tapping, and associated arts such as security information and event management (SIEM), Security Orchestration, Automation, and Response (SOAR), deep packet inspection (DPI), and SCADA, and do not by themselves constitute the present invention. As non-limiting examples, the invention may be practiced in conjunction with nodes that operate in accordance with various operating systems, (e.g., Linux™ or Windows™), cooperate in accordance with cluster management software (e.g., Kubernetes™), and communicate with each other in accordance with various protocols (e.g., HTTP/HTTPS, MQTT, Ethernet/IP, Modbus/TCP, etc.).

The system 200 may be conceptualized by functional modules that work collaboratively to identify, respond to, and notify a user of the system 200 of cybersecurity events. It will be understood that the modules are in actuality implemented as sets of instructions, which may include rules as described herein, stored on memory 204, which are executable by processor 202 to implement methods as described below. The memory 204 storing these instructions may be considered to be a “computer program product” of the present invention. These functional modules include a Security Threat Score module 304, a Security Threat Matrix module 306, a Security Threat Mask module 308, a Path Threat score module 310, an Access Control module 312, an Event Escalation module 314, and a Security Dashboard module 316, as are further described below. The Security Threat Matrix module 306, a Security Threat Mask module 308 collectively form a Security Alert Subsystem 318.

In the embodiment of FIG. 3, the system 200 also includes a data buffer 320, which will be understood to be a memory. Data buffer 320 may be part of memory 204, or a distinct memory. The data buffer 320 can be used to store information used and/or generated by processor 202 executing instructions of the Security Threat Score module 304, and the Access Control module 312, and other modules. In embodiments, data buffer 320 may be isolated in a manner similar to a “security sandbox”, by being used to store the minimum information necessary for operation of the system 200, but no additional information that could potentially compromise the cybersecurity of system 200.

### Security Threat Score Module 304.

A purpose of the Security Threat Score module 304 is to determine at least one, and in embodiments a plurality of, cybersecurity threat scores—i.e., scores relevant to the cybersecurity—of a node of a network (e.g., SCADA system 100). Such scores may be determined on a node-by-node basis.

In general, the method implemented by the Security Threat Score module 304, possibly in cooperation with cybersecurity tools 300, includes the following steps:
(a) storing in a memory 204, at least one rules (and optionally, a plurality of unique pre-defined rules) (i.e., mathematical and/or logical relationship(s) such as Boolean test(s)) for determining at least one (and optionally, a plurality of) cybersecurity threat score(s) for the node based on network information associated with the node;
(b) using a processor 202, monitoring the network to acquire the network information; and
(c) using the processor 202, determining (and optionally updating values) of the score(s), optionally in real time, based on the acquired network information and in accordance with the rule(s).

Steps (a) to (c) may be performed in respect to each node of network. Further, steps (b) and (c) may be performed, in sequence, repeatedly, to continuously update values of the score(s) for the node.

“Network information associated with a node” refers to information indicative of one or a combination the following: (i) a volume or pattern of data packet traffic transmitted and/or received by the node: (ii) an attribute of a data packet transmitted to or received by the node, such as a size, contents, or communication protocol of the data packet: (iii) a network address of the node: (iv) a connection relationship of the node to other nodes(s) in the network; (v) an identifier of a user, or a role of a user, of the node: (vi) an identifier of a node: (vii) data encoded in a data packet indicative of an operational parameter of a node: or (viii) a change to any one or more of the foregoing.

As noted, each of the rules is unique. This uniqueness of each rule may be attributable to one or a combination of: the type of network information associated with the node used to determine the score: the combination of types of network information associated with the node used to determine the score: the relationships (e.g., mathematical and/or logical relationships) that define the score based on the network information associated with the node. By defining a plurality of cybersecurity threat scores in this manner, the method advantageously allows for a multi-faceted assessment of the cybersecurity risk associated with the node.

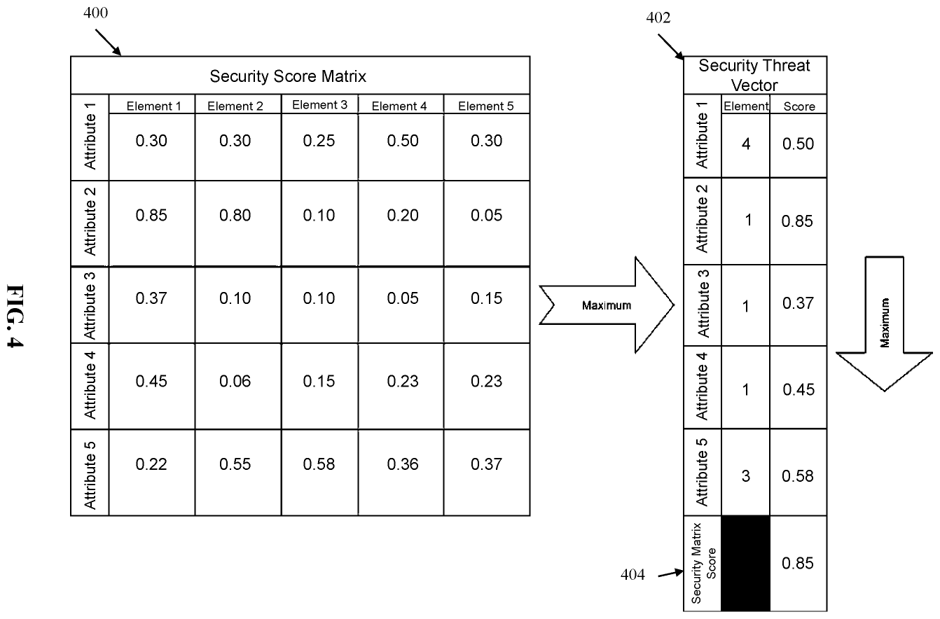

Referring to FIG. 4, the plurality of cybersecurity threat scores may be conceptualized as a security score matrix 400, defined by a number of rows of “Attributes”, each having a number of columns of “Elements.” In this example, the matrix has five rows of Attributes, and five columns of Elements per Attribute, but it will be understood that other numbers of Attributes and Elements per Attribute are possible. Each “Attribute” can be considered to be a key category of information relating to the node that impacts cybersecurity threats. Each “Element” can be considered to be a metric that contributes to that Attribute. Thus, each cell of the security score matrix 400 corresponds to one of the cybersecurity threat scores associated with the node, and as uniquely defined by one of the rules stored in the memory 204.

By way of illustrative examples, the “Attributes” may include categories of node “Accessibility”, node “Connections”, node “Network Traffic”, node “Operational Data”, node “User or Node Profile Data”.

“Accessibility” may refer to the network location of the node, in geographic terms, and/or relative to a network domain or zone, or other feature of a topology of the network. As an illustrative example, the Security Tools 300 may scan the network (e.g., SCADA system 100) to create an inventory or map of the nodes, and determine their associated IP addresses. A stored rule may use the IP address of the node as its associated network information to determine whether or such IP address is inside or outside the network domain or zone (e.g., of the SCADA system 100). The rule may determine a higher score value (indicating a higher cybersecurity threat) if the IP address is outside the network domain or zone, than if the IP address is inside the network domain or zone. The network location of a node may be determined by the Access Control module 312, as described below.

“Connections” may refer to a network location or a change in network location of the node. As an illustrative example, the Security Tools 300 may scan the network to create an inventory or map of the nodes, and determine their associated domains, zones, and/or IP addresses, as noted above. A stored rule may use the network address (e.g., IP address) of the node as its associated network information, and compare it with a “whitelist” of approved connections to the network. The IP address being outside the set of approved connections may be indicative of an unauthorized change (e.g., due to the node being “hacked”), and thus the rule may determine a higher score value (indicating a higher cybersecurity threat) if the IP address is outside the set of approved connections, than if the IP address is inside the set of approved connections.

“Network Traffic” may refer to metrics, such as volumes or patterns, of data packet traffic transmitted and/or received by the node. As an illustrative example, the Security Tools 300 may monitor ports of the network to determine the volume or patterns of data packets received by the node within a given time interval. A stored rule may comprise a predefined mathematical relationship that operates on this volume to determine one of the scores. For example, assuming for illustrative purposes a scoring scale of 0-10, for a low volume of data packets, the mathematical relationship may determine a score of “0” indicative of a low cybersecurity threat. Conversely, for a high volume of data packets, the mathematical relationship may determine a score of “10” indicative of a high cybersecurity threat due to an event such as a “denial-of-service” (“DOS”) attack. The present invention is not limited by any particular mathematical relationship. As non-limiting examples, the mathematical relationship between the score and the volume of data packets may be defined by one or more linear function(s), non-linear function(s), step-function(s), or a combination of them.

“Operational Data” may refer to data indicative of an operational parameter of a node. The operational parameter may be one that is relevant to a process controlled by SCADA system, and defined by a measurable property associated with a node. As such, non-illustrative examples operational data may be a pressure, temperature, flow rate, a mass, a weight, a speed, an actuation rate, an actuation frequency, an electrical current, voltage, power or other electrical or analog or digitally transmitted signal parameter, of the node, of a physical device associated with a node, of a material associated with the node (e.g., a material input or output used in an industrial process). Additional non-limiting examples of operational data include quality indicators of data signals transmitted or received by a node (e.g., “in range”, “out of range”, or signal strength metrics), device status indicators that may be generated by nodes (e.g., “good,” “bad”, “uncertain”, “in service”, “out of service”), and other diagnostic messages that may be generated by nodes.

“User or Node Profile Data” may refer to data indicative of one or a combination of an identity, a role, or an authorization level of a user that is using or accessing the node to generate, transmit, and/or receive data, or of the node itself. Such information may be prescribed for a node, encoded in a data packet in use of the node, generated when the user “logs onto” a node, or by other means. As a non-limiting example, different users may have different roles (e.g., operator, supervisor, maintenance, engineer, administrator, etc.), which the rules may differentiate between to determine different cybersecurity threat scores. For example, a rule may determine a higher cybersecurity threat score in respect to a node used by an “operator” than in respect to a node used by an “administrator”. As another non-limiting example, different nodes may have different profile information inherent to the nodes themselves, such as a unique alphanumeric identifier. Such information may be assigned by an administrator of the system 200, or provisioned by being “hard-coded” into a node or part thereof, with examples being an International Mobile Subscriber Identity (IMSI) number, an International Mobile Equipment Identity (IMEI), a mobile equipment identifier (MEID), or other uniquely identifying alphanumeric identifiers. A rule may determine different cybersecurity threat scores depending on the node profile information. For example, the rules may determine a lower cybersecurity threat score for a node having an identifier indicating that it is a permanent part of a SCADA system, and a higher cybersecurity threat score for a node having an identifier indicating that it is a user's BYOB (“bring your own device”) smartphone or tablet computer that connects to the network (e.g., SCADA network 100) only on a temporary basis.

The rules may use a variety of network data to determine the scores. As further non-limiting illustrative examples, the Security Tools 300 may “inspect” a data packet transmitted and/or received by a node to determine its attributes such as its contents and/or size. A stored rule may compare such contents and/or size to pre-defined expected attributes of data packets that are expected to be transmitted and/or received by the node, and determine a numerical score value based on this comparison. As a non-limiting illustrative example, a node such as a temperature sensor may be expected to transmit packets of sensor data of a known size or size range. If a data packet transmitted by the node is of the known size or within the known size range, then the rule may determine a score of “0” indicative of a low cybersecurity threat. Conversely, if the data packet transmitted by the node is larger than the known size or outside of the known size range, and/or has contents other than numerical temperature data, then the rule may determine a score of “10” indicative of a high cybersecurity threat, due to an event such as the node being used to transmit an attack vector on the SCADA system 100.

Once the plurality of cybersecurity threat scores have been determined as described above, the processor 202 may process them for more convenient threat assessment by determination of a Security Threat Score (STS) that takes into account all of the determined scores. As an illustrative example, the Security Threat Score (STS) may be determined in accordance with the following equations.

$$Attribute Score ( {A}_{n} ) = ( ( {e}_{1} * {EL}_{1} ) + ( {e}_{2} * {EL}_{2} ) + ( {e}_{3} * {EL}_{3} ) + … ( {e}_{n} * {EL}_{n} ) ) / ( {e}_{1} + {e}_{2} + {e}_{3} + … {e}_{n} ) \qquad Equation 1$$

$$Security Threat Score = ( ( ( {a}_{1} * {A}_{1} ) + ( {a}_{2} * {A}_{2} ) + ( {a}_{3} * {A}_{3} ) + … ( {a}_{n} * {A}_{n} ) ) / ( {a}_{1} + {a}_{2} + {a}_{3} + … {a}_{n} ) ) ) * 10 \qquad Equation 2$$

That is, Eqn. 1 determines the Attribute Score for each of the individual Attributes (Aₙ) of the node as the normalized sum of the scores for individual Elements (ELₙ) and their associated weighting factors (eₙ). Eqn. 2 determines the Security Threat Score (STS) for each node as the normalized sum of the scores for the individual Attributes (Aₙ) and their associated weighting factors (aₙ). The normalized Security Threat Score (STS) is multiplied by a factor (for this example, “10”) to provide better resolution for the associated interfaces. The weighting factors (aₙ) for the attributes and the weighting factors (eₙ) for the Elements may be determined individually and assigned at the time of system configuration using templates developed for each node class as the initial starting point for the weighting factors. For example, the weighting factors (aₙ) for each Attribute may be pre-defined based on factors such as the type of device that makes up the node, the criticality of the node to the cybersecurity of the network, and the criticality of the node to the safety and reliability of an industrial process affected by the node.

In embodiments, the weighting factors may be fixed. In other embodiments, the weighting factors can change as data, knowledge, and understanding of the network system, and attack vectors, increases and evolves during use. In some embodiments, the system 200 may be configured so that a human user can manually update some or all of the weighting factors. In addition or alternatively, the system 200 may be configured to automatically update some or all of the weighting factors through the use of a plurality of rules and algorithms. As a non-limiting example, machine learning/artificial intelligence (ML/AI) algorithms may be used to determine the values of the weighting factors by operating on a “training” dataset of known Security Threat Scores, and associated scores for individual Elements, and then validating the determined values of the weighting factors operating on an independent “validation” dataset of known Security Threat Scores, and associated scores for individual Elements. A variety of machine learning models may be used for this purpose, such as artificial neural networks.

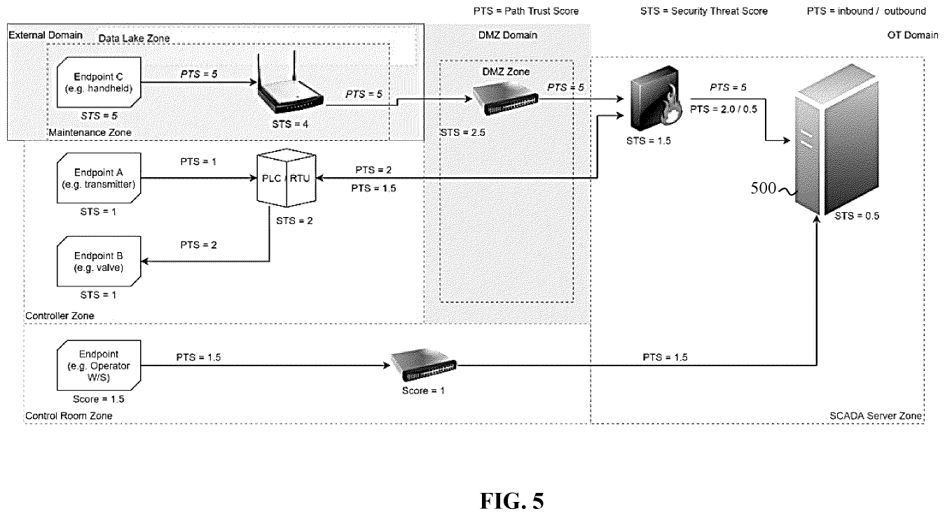

Once the Security Threat Score (STS) has been determined, the processor 202 may control the Security Dashboard module 316 to display a report of the Security Threat Scores (STSs) on a node-specific basis, such as on display device 208. FIG. 5 shows an example of such a report in graphical form illustrating the various nodes (e.g., handheld device, transmitter, valve, operator workstation, PLC, RTU, router, uplink connection, hardware firewall, and supervisory computer) of a network in the form of a SCADA system. Each node is labelled with “STS=n”, where “n” is the value of the Security Threat Score (STS) determined for the node.

Once the Security Threat Score (STS) has been determined, the processor 202 may compare them to one or more predetermined Security Threat Score Threshold(s) to control the Security Dashboard module 316 to display one or more alerts (e.g., a human-readable message, signal or indicator) on display device 208. For example, if the processor 202 determines that the Security Threat Score (STS) is less than a lowest value of Security Threat Score Threshold, then the processor 202 may control the Security Dashboard module 316 to display a “Level 0—No active threat” alert. Conversely, if the processor 202 determines that the Security Threat Score (STS) is greater than a highest value of Security Threat Score Threshold, then the processor 202 may control the Security Dashboard module 316 to display a “Level 5—Access Denied” alert, and further control the system 200 to isolate the node in the network. It will be understood that the Security Threat Score module 304 and the Security Dashboard module 316 may be configured for any desired number of alert levels with desired Security Threat Threshold(s), depending on the requirements and objectives of monitoring a particular network.

### Security Alert Subsystem 318.

A purpose of the Security Alert Subsystem 318 is to avoid the risk of weighting factors used in determination of the Security Threat Score (STS) effectively masking the potential impact of individual Attributes and Elements. In this manner, the Security Alert Subsystem can facilitate identification of abnormal network activity, so that the system 200 can initiate appropriate actions in response. Referring back to FIG. 3, the Security Alert System comprises the Security Threat Matrix module 306 and the Security Threat Mask module 308. These modules work cooperatively to identify the highest risk Elements to the network (e.g., SCADA system 100). The processor 202 may perform logical operations on their outputs and control the Security Dashboard module 216 to cause the display of one or more alerts (e.g., a human-readable message, signal or indicator) on display device 208.

### Security Threat Matrix Module 306.

The method implemented by the Security Threat Score module 304, includes the step of identifying the maximum cybersecurity threat score determined for a node.

Referring to FIG. 4, the plurality of cybersecurity threat scores may be conceptualized as a security score matrix 400, as described above.

In one embodiment, the processor 202 determines a Security Threat Vector 402 comprising paired values of the maximum cybersecurity threat scores determined for each Attribute of the node and the corresponding Element identifier. The Security Threat facilitates identifying the Element associated with highest cybersecurity threat for each of the Attributes while also providing an indication of how broadly threat(s) are evolving across the network. For example, if only the “Network Traffic” Attribute is affected, then it could indicate failure of a node, rather than a targeted “denial-of-service” attack.

In one embodiment, the processor 202 then determines a Security Matrix Score (SMS) 404 as the maximum value of the maximum cybersecurity threat scores in the Security Threat Vector 402. The Security Matrix Score facilitates identifying the highest cybersecurity threat to the network. The system 200 can then correlate this to the different alert levels and take an associated response action (e.g., isolating a node in a network, disabling a node in a network, or some intermediate or alternate action) to prevent the threat from propagating to an actual incident or event.

The processor 202 may store the Security Threat Vector 402 and the Security Matrix Score 404, optionally with an associated time stamp in the memory 204. This stored information can be used for event reconstruction. Further, machine learning and related computational techniques may use this stored information to train variable response models.

### Security Threat Mask Module 308.

A purpose of the Security Threat Mask module 308 is to facilitate identification of vulnerabilities that could prevent or compromise the network (e.g., SCADA system 100) from operating normally, having regard to the type of device making up the node, its use(s) and its function(s).

In general, the method implemented by Security Threat Mask module 308 includes the following steps:
(a) storing in the memory 204, for each of the cybersecurity threat scores, at least one associated pre-defined test comprising: whether the score exceeds a predetermined threshold value or is outside of a predetermined threshold range;
(b) using the processor 202, for each of the cybersecurity threat scores, determining a result of whether each of the at least one test is satisfied, in real time.

In embodiments, the at least one associated pre-defined test comprises a plurality of different tests. In one embodiment, a first one of the tests is defined based on a type, class, or function of device making up the node, and another one of the test is defined based on the operational performance of the node. In embodiments, the method includes a further step of using the processor 204 to perform a logical operation on the results of the tests for each of the cybersecurity threat scores to determine an alert level.

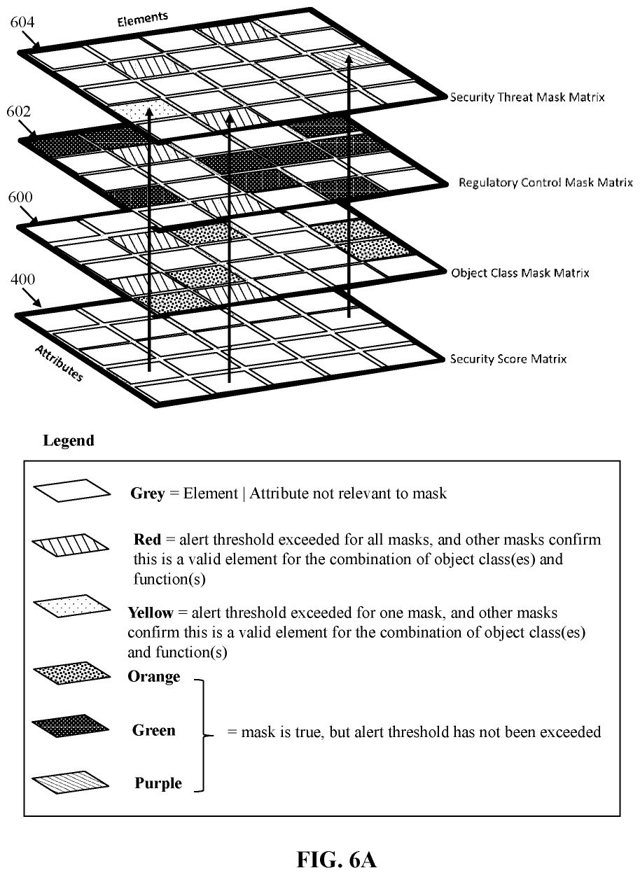

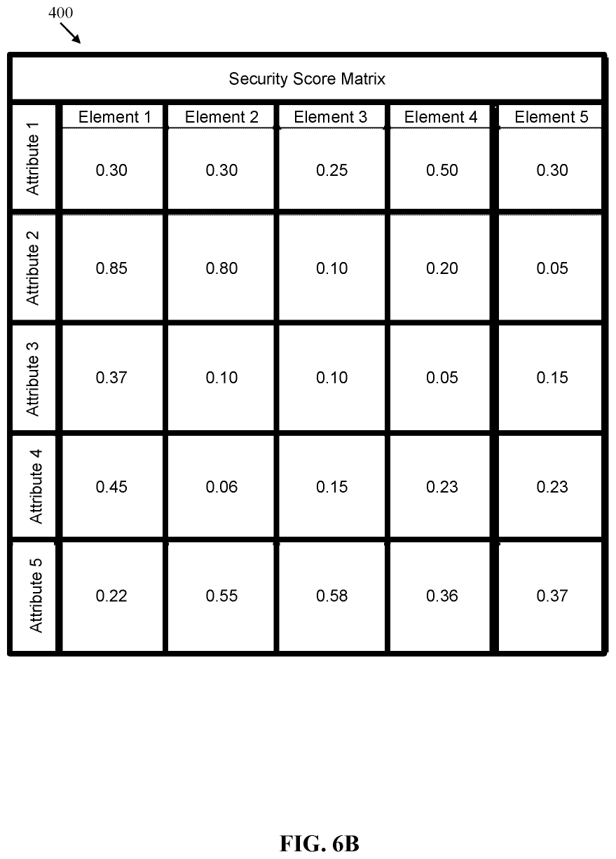

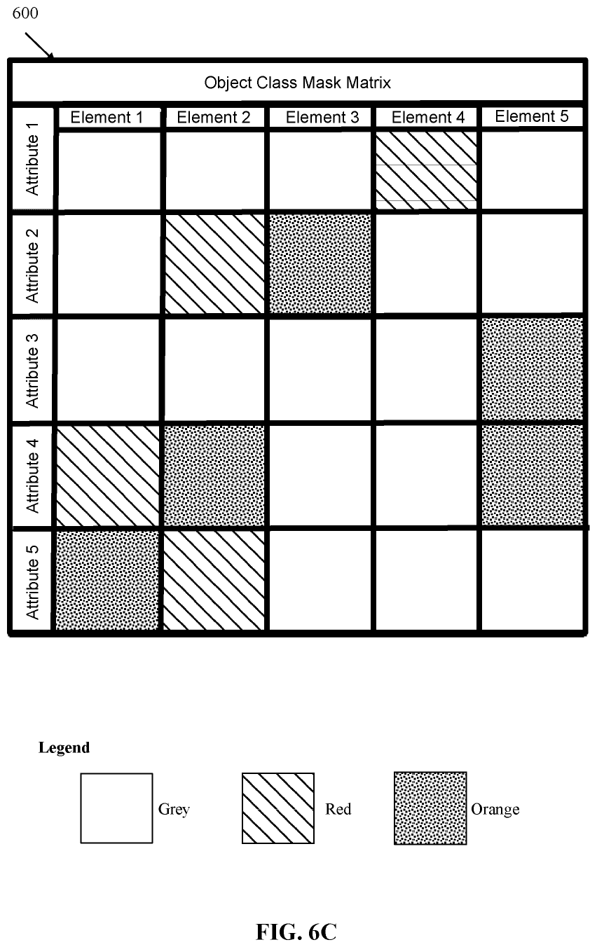

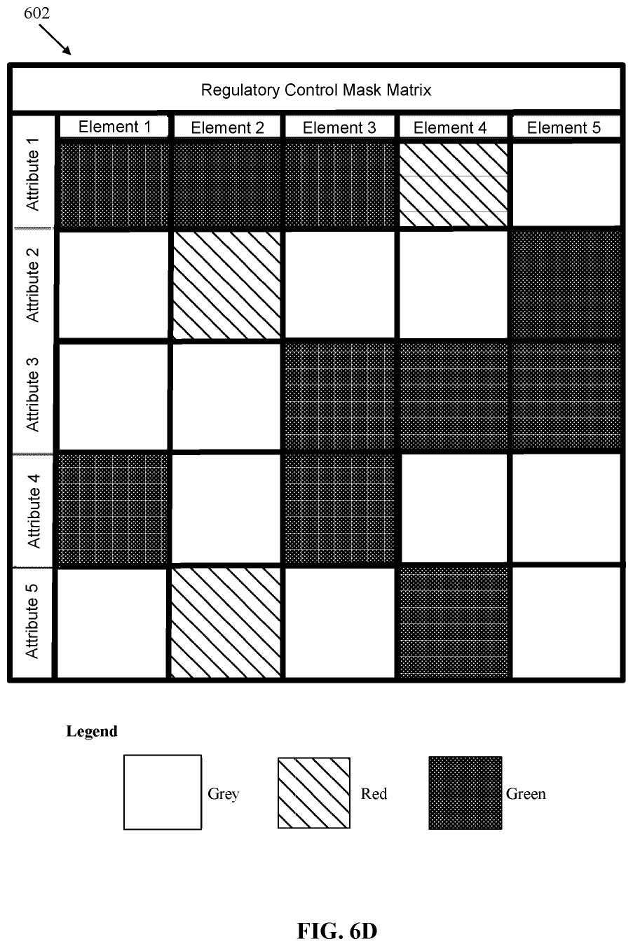

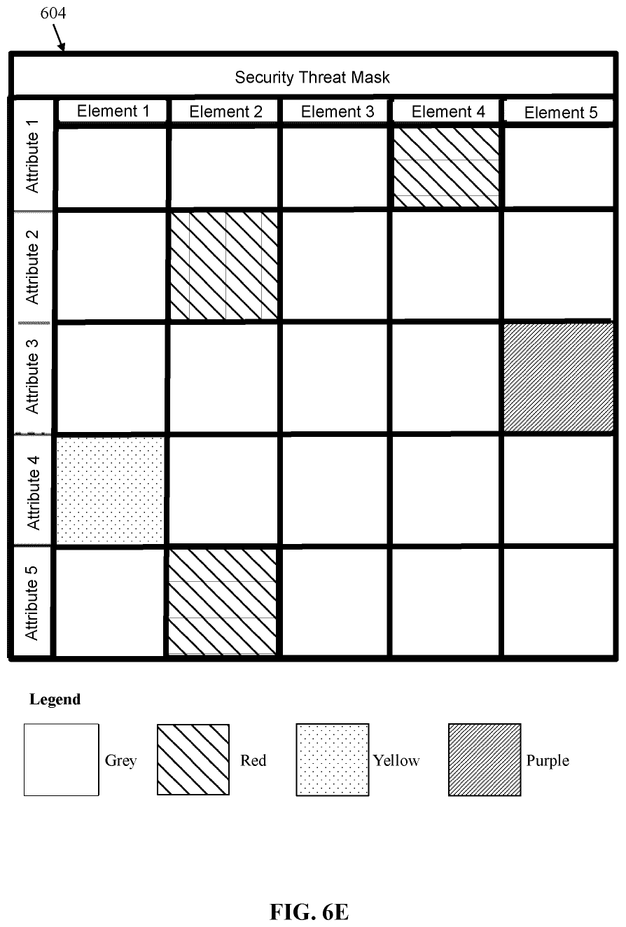

Referring to the example of FIG. 6A, the plurality of tests may be conceptualized as series of “Mask Matrices” 600 and 602 having elements that overlie corresponding elements of the Security Score Matrix 400. In this illustrative example, there are two mask matrices 600 and 602. In other embodiments, there may be one or a plurality of mask matrices (i.e., any integer number 1 to ‘n’, where n is greater than or equal to 2), dependent on the requirements and objectives of monitoring a particular network. Each mask matrix may be configured to apply different tests to elements of the Security Score Matrix 400. As mentioned above, the tests may depend on the type, class or function of the device making up the node, or the operational performance of the node (as are illustrated below).

As another example, a mask may comprise tests that depend on the role of a user of the node (e.g., operator, supervisor, maintenance, engineer, administrator, etc.), and be relevant to cybersecurity threat scores based on “User Profile or Node Data” attribute data as discussed above.

As another example, a mask may comprise tests that depend on a geographic location of the node, or a location of a node within a topology of the network (e.g., SCADA system 100), such as whether the node is within a certain domain or zone and be relevant to cybersecurity threat scores based on node “Accessibility” attribute data as discussed.

As another example, a mask may comprise tests that depend on the communication protocol used by the node, as different protocols and field buses are susceptible to different vulnerabilities.

As another example, a mask may comprise tests that depend on a reliability or safety rating of a node (e.g., its safety integrity level (SIL)), which may depend on signal integrity of the node.

Each element of the mask matrix 600 or 602 has a pre-defined test that is applied to the underlying Cybersecurity Threat Score. In this illustrative example, the first mask 600 (labelled “Object Class Mask Matrix”) is pre-defined based on a type or class of device making up the node. For example, a first mask matrix for a node that is a valve may be pre-defined in a different manner than a first mask matrix for a node that is a PLC or RTU. The rationale for doing so is that certain elements of the Security Score Matrix 400 that are relevant to the valve may not be relevant to the PLC or RTU, or vice versa, or have been subject to different thresholds before triggering an alert level.

In this illustrative example of FIG. 6A, the second mask matrix 602 (labelled “Regulatory Control Mask Matrix”) is pre-defined based on operation of the node. For example, this second mask matrix may be for a node that is a valve. Under normal conditions, the operational parameters may be used to generate elements of the Security Score Matrix 400, as described in above in respect to the “Operational Data” Attribute. The second mask matrix for this node may test whether the scores in these elements are within pre-defined ranges of threshold values. In contrast, these considerations might not be relevant to a node that is a computer that merely provides a human interface for results, and therefore, the tests of the second mask matrix may simply set these elements being non-relevant to assessing the cybersecurity threat associated with this node.

In this illustrative example of FIG. 6A, the uppermost layer is a Security Threat Mask Matrix 604 indicating an alert level resulting from a logical operation performed on the first mask matrix 602 and the second mask matrix.

The results of the test applied to the underlying Cybersecurity Threat Score are, for illustrative purposes and to aid in understanding of the concept, color-coded in the first mask matrix 600 and the second mask matrix 602. A grey element in the mask matrix 600 or 602 indicates that the Element and Attribute pair is not relevant to assessing the cybersecurity threat of its subject node. A colored element (e.g., orange or green) indicates that the Element and Attribute pair is relevant to assessing the cybersecurity threat of the subject node, but the Cybersecurity Threat Score does not exceed the predetermined threshold value of the test in the mast matrix 600 or 602.

The alert level resulting from the logical operation performed on the first mask matrix 600 and the second mask matrix 600 is color-coded in the Security Threat Mask Matrix 604. A grey element in the Security Threat Mask Matrix 604 indicates that the Element and Attribute pair is not relevant to assessing the cybersecurity threat of the subject node, for one or both of the first and second mask matrices 600 or 602. This is equivalent to a logical “OR” operation for non-relevance of either mask matrix 600 or 602. A purple element in the Security Threat Mask Matrix 604 indicates that the Cybersecurity Threat Score does not satisfy the test of exceeding the predetermined threshold value for either one of the mask matrices 600 or 602. A yellow element in the Security Threat Mask Matrix 604 indicates that the Cybersecurity Threat Score satisfies the test of exceeding the predetermined threshold value for only one of the mask matrices 600 or 602. A red element in the Security Threat Mask Matrix 604 indicates that the Cybersecurity Threat Score satisfies the test of exceeding the predetermined threshold value for both of the mask matrices 600 and 602. This is equivalent to a logical “AND” operation for exceeding the predetermined threshold value for both of the mask matrices 600 and 602. In this example, the purple, yellow and red color-coding of the Security Threat Mask Matrix 604 indicates that the Cybersecurity Threat Scores for five of the Element and Attribute pairs potentially compromise the integrity of the regulatory control. Although possible, it is unlikely to have multiple Element and Attributes pairs potentially reach an alarm state in one cycle, and therefore this example may represent a situation of an escalating cybersecurity threat.

In embodiments, the processor 202 may perform above steps (a) through (c) of the Security Threat Mask module 308, in sequence and in real time, repeatedly at successive times, and monitor in real time for changes in the alert levels from one iteration of step (c) to a subsequent iteration of step (c). This may be useful in detecting an escalating cybersecurity event. Pattern recognition algorithms applied to the alert levels may be used to detect evolving cybersecurity events.

### Path Trust Score Module 310.

A purpose of the Path Trust Score module 310 is to determine an indicator of the level of cybersecurity threat along different data message paths of the network.

FIG. 5 shows an example of a report in graphical form illustrating the calculated Path Trust Scores (PTS). For message paths where data transmission is bi-directional, an inbound and outbound Path Trust Score (PTS) may be determined in the direction of data transmission. As will be apparent from FIG. 5, for a particular direction of data transmission in a message path, the processor 202 determines the Path Trust Score (PTS) as the maximum Security Threat Score (STS) of node(s) along the path.

In the illustrative example of FIG. 5, a server computer 500 receives data along three message paths: a first message path from an input device (Endpoint A); a second message path from Handheld device (Endpoint C); and a third message path from operator workstation. For the first message path, the Path Trust Score (PTS) for the segment from Endpoint A to the PLC/RTU is “1” because the Security Threat Score (STS) of Endpoint A is “1.” The Path Trust Score (PTS) for the segment from the PLC/RTU to the firewall hardware is “2” because the Security Threat Score (STS) of the PLC/RTU is “2”. The Path Trust Score (PTS) for the segment from the firewall hardware to the server is “2.0” because the Security Threat Score (STS) of the PLC/RTU is “2”, even though the Security Threat Score (STS) of the firewall hardware is only 1.5. The Path Trust Score (PTS) for the segments of the other message paths are determined in a like manner, as the maximum of Security Threat Scores (STSs) of node(s) along the path, in a given direction of data transmission.

In embodiments, when calculating the Path Trust Score, the processor 202 may also check the actual versus configured path based on IP addresses for each node, and generate an alarm when there is a deviation in the IP addresses.

### Access Control Module 312.

A purpose of the Access Control module 312 is to determine an access control score, which is used by the security system 200 to factor the impact of a data packet's originating node source/location relative to the Domains and Zones as defined for the security system 200. The access control score determines how a user's or node's authentication/authority changes, based on how or from where they are accessing the network (e.g., SCADA system 100). The Access Control module 312 may perform these functions in real time in respect to data transmission originating from a node.

“Domain”, as used herein, refers to an administrative group of network assets (including nodes), as may be identified by a domain name, topology, other identifier of a network, or other shared attribute. In one embodiment, the nodes of a common domain may be identified as the nodes operating under a single security policy. As a non-limiting example of the latter case, the nodes may be operating under public key certificates created by a single authority or by a set of authorities using the same security policy.

“Zone”, as used herein, refers to a portion of network assets (including nodes) within a domain that share the same cybersecurity requirements. In embodiments, a zone may be based on a grouping of logical or physical assets that share common security requirements based on factors such as criticality and consequence.

For example, as shown in FIG. 5, the SCADA system has an “External Domain”, a “DMZ Domain” (demilitarized zone domain), and an “OT Domain” (operational technology domain). The “OT domain” includes a “Controller Zone” including a transmitter and a valve as nodes, a “Control Room Zone” including an operator workstation (W/S) as a node, and a “SCADA Server Zone” including a server computer as a node and firewall device as a node.

In general, the method implemented by the Access Control module 312, possibly in cooperation with cybersecurity tools 300, controls the response of the network to a data packet addressed from a first node having a first node location in the network to a second node having a second node location in the network. The first and second node locations may be determined from the data packet contents (e.g., source and destination network addresses of an address header). The method includes the following steps implemented by the processor 202:
(a) in accordance with at least one rule stored in a memory 204, determining an access control score based on the first node location and the second node location; and
(b) based on the score determined in step (a), controlling the response comprising one or a combination of:
   (i) either allowing or preventing transmission of the data packet to the second node, depending on the access control score;
   (ii) varying a cybersecurity threat score for the second node based on the access control score: or
   (iii) causing a display device to display the access control score, a value derived from the access control score, or an alert based on the access control score.

The Access Control module 312 may assign different Access Control scores to a first node depending on its location, and the location of a second node on which the first node is acting (i.e., a second node to which the first node is transmitting data). As examples, the Access Control module 312 may assign different Access Control scores depending on which of the following situations applies:
the first and second nodes are located within the same zone;
the first and second nodes are located in different zones (i.e., the first node is acting across zone(s) on the second node);
the first node and second nodes are in the same domain (i.e., control, SCADA, Safety, Human Machine Interface (HMI), etc.);
the first node and second nodes are in the same enterprise domain (i.e., operational technology (OT) domain, demilitarized zone (DMZ) domain, information technology (IT)) domain;
the first and second nodes are located in different enterprise domains (i.e., the first node is acting across enterprise domains (i.e., OT to DMZ, or DMZ to IT) on the second node); or
the first node or the second are located in an external domain (i.e., supplier, client/customer, cloud, etc.)—that is a domain that is external to the network (e.g., SCADA system 100).

As an example, if the two nodes are not from within the same zone, then the Access Control module 312 verifies that the nodes are from within the same Domain (OT, IT, or External) and continues this analysis through the various network layers. Based on the resulting data and identity of the where the first node is located, the associated logic and configuration information, the Access Control module 312 determines an access control score and a corresponding appropriate system response to data packets originating from the first node. For example, the stored rule may determine a higher access control score (indicative of a lower cybersecurity threat) if the first node location and the second node location are within the same domain or the same zone, and a lower access control score (indicative of a higher cybersecurity threat) where one or more of the first and second node locations are external to the network.

In addition, or in the alternative, the Access Control module 312 may assign different access control scores to the first node based upon its cybersecurity threat score(s), or the Attributes or Elements on which the cybersecurity threat score(s) are computed, or a value derived from them, such as the Security Threat Score (STS), as determined by the Security Threat Score module 304, as described above. As a non-limiting example, the memory may store an inverse relationship that defines the Access Control score based on the Security Threat Score (STS) or an Attribute thereof. Thus, where the node has a higher Security Threat Score (STS) (in this example indicative of a higher cybersecurity threat), the Access Control score will be lower (in this example, suggesting a tendency toward controlling the network to provide the first node with a lower level of access to the second node.)

The response of the second node or algorithm dependent on the information from the originating (first) node (i.e., the access control score) for example could include one or more of the following actions:
allow for transmission of the data packet, and proceed with the computation and resultant action, using the data received from the first node;
revise/increase the Security Threat Score for the second node;
flag the data packet as suspect, and notify the user through use of the Security Dashboard module 316; and/or
isolate the data packet—i.e., prevent transmission of the data packet to the second node, or further in the network (e.g., SCADA system 100).

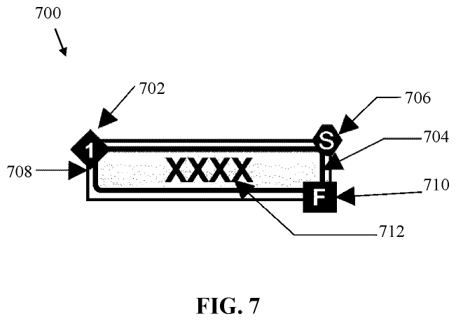

As an example of notifying the user through use of the Security Dashboard module 316, FIG. 7 shows an example of graphical user interface element that can be displayed by a display device 208, as will be further described below. In FIG. 7, the Security Score Indicator 706 (based on change in STS) and Data Quality Indicator 710 (invalid input data) can be affected by the Access Control score, if the action to the second node is executed.

Illustrative examples of the operation of the Access Control module 312 are described in the below scenarios with reference to FIG. 5.
1. Scenario 1: Local communications and regulatory control between Endpoint A and Endpoint B through the local PLC/RTU controller. These nodes are in the same Zone. Accordingly, the Access Control score has no impact on data transmissions between these nodes.
2. Scenario 2: Change in setpoint for Endpoint B (e.g., valve in Controller Zone) from the Operator Workstation (Control Room Zone). These nodes are both within the OT/SCADA domain, but in different zones. This is reflected in the Access Control score as crossing zones, but as per configuration is within the same OT domain (firewall), and therefore has no impact on data transmissions between these nodes.
3. Scenario 3: Maintenance technician connects a handheld device (Endpoint C) through an external network to write/send a command to Endpoint B. The Access Control score identifies that this handheld device is from an External Domain and therefore disallows the write of the command, while recording the incident as a potential attempt at compromise to cybersecurity of Endpoint B. Based on the User profile of Endpoint C, the DMZ Domain and Firewall are configured to allow Endpoint C to read and write limited values associated with maintenance functions, with the access control score as an additional level of protection.

As noted above, in the event that the access control score is too low (e.g., because the Security Threat Score is too high), the processor may control the network to not use a data packet transmitted from the first node. However, the Access Control module 312 may extract or raw process values from the data packet (e.g., from its payload) and save them with a time stamp to the Data Buffer 320 memory. The time stamp may be indicative of the time of attempted transmission of the data packet, which may be substantially contemporaneous with the Access Control module 312 preventing transmission of the data packet in real-time. The network (e.g., SCADA system 100) can then access this data stored in the Data Buffer 320 memory in the event the data is required for other calculations, and continued normal operation of the network (e.g., SCADA system 100) (e.g., continued normal operation of its regulatory control loops). In this manner, the overall reliability of the network (e.g., SCADA system 100) is not affected, to avoid an interruption to the network that could result in an unsafe condition.

### Event Escalation Module 314.

The nature of cybersecurity events is evolving with threat vectors lurking and operating in the background for longer periods of time, and gathering data and information on the system beforeproceeding to the next stage in the exploit cycle. Industry regularly becomes aware of the vulnerability and shares this information through various means during the extended periods between the initial access and the weaponization and execution of the potential exploit. Unfortunately, unlike a process which tends to naturally self-correct or escalate as driven by underlying process dynamics, unless addressed, security vulnerabilities continue to escalate without any or at most minimal outward signals until activation.

The Event Escalation module 314 is a tool with which the system 200 helps to ensure timely action is taken to eliminate threats before they escalate to events/incidents by increasing the severity of the risk to reflect timeliness of implementing a corrective maintenance response relative to its impact, for which the likelihood of occurrence continues to increase with time.

In general, the Event Escalation module 314, possibly in cooperation with cybersecurity tools 300, implements a method that includes the following steps:
(a) transmitting a first notification to a first node or user of the network to take a maintenance action for the network within a time period node; and
(b) if the maintenance action is not taken within the time period, escalating the first notification, by transmitting a second notification to a second node of the network to take the maintenance action.

The maintenance action may include installing software (e.g., a software patch), storing data to memory (e.g., backing up data to a server), and/or removing a hardware or software component (e.g., a hardware or software component that has reached its end of life or end of support).

The Event Escalation module 314 maintains an inventory of the firmware and software to identify vulnerabilities such as:
patch updates;
vulnerability announcement(s);
system backup compliance; and
end of life/end of support for different system elements (e.g., software or hardware associated with nodes of SCADA system 100).

The Event Escalation module 314 is tasked with monitoring the network components and identifying and/or confirming if these vulnerabilities are applicable to the installed system components, and then monitoring and providing notifications to the user to ensure the corrective maintenance action (e.g., installing software such as a software patch, performing a system backup to a memory by storing data to a memory, and/or replacing or removing a hardware or software component that is nearing its End of Life or End of Support) is taken in a timely fashion within a prescribed time period. The basic premise and potential configuration options for user notifications (e.g., as displayed on display device 208) of a subset of the above vulnerabilities are:
Initial notification of automated or semi-automated responses (vulnerability, firmware or software patch, virus pattern, system backup); if an automatic update is not performed within ‘x’ time, then the Event Escalation module 314 prompts the user to manually investigate (e.g., through an alert displayed on display device 208);
Initial notification of patch/resolution available, with configuration to check for user response within ‘x’ time after the resolution is available; and
Notification at ‘x’ time in advance of End of life, with configuration to escalate.
   Like other notifications and alerts generated by the system 200, the Event Escalation module 314 can provide for multiple alarm levels with associated thresholds determined at configuration.

The role of the Event Escalation module 314 is to raise awareness of the issues to the original responsible entity. As well, when the severity exceeds a configurable defined threshold (e.g., when a corrective maintenance action has not been taken within a prescribed time period ‘x’ discussed above), the Event Escalation module 314 escalates the need to respond to additional (supervisory) entities. This escalation can be implemented by sending notifications addressed to different nodes and/or different user addresses (e.g., email addresses) associated with supervisory entities. The initial escalation response will be analogous to and potentially use the same notification system as the Security Threat Score module 304. The Event Escalation module 314 has the additional benefit of being able to notify external parties so that, when required, it can be integrated with other site activities (i.e., plant shutdown that may require a system reboot while the process is in a safe state) and be incorporated into those activities.

### Security Dashboard Module 316.

To be able to interact with the process operators, the Security Dashboard module 316 may cause the display device 208 to present the results of the system calculations and results, as discussed above, as a combination of reports, schematics, and faceplates and other human-readable elements.

FIG. 7 is an embodiment of a graphical user interface (GUI) element 700 that is used to report cybersecurity information to a user of the system of the present invention. The GUI element 700 is in the form of “faceplate” or “tag” for a node, which serves as a template for a variety of variable cybersecurity information elements. Changes to the faceplate information elements inform the operator at a glance of the status of the individual nodes. Like an alarm, this change of state is used to inform them that the node or network has entered an anomalous state such as exceeding an operating limit, a security issue, or indicating an underlying potential problem with the signal integrity used to control the process. In this embodiment, the GUI element 700 includes several sub-elements as follows. An “Alarm Indicator” 702 may be used to indicate the level of an alert determined in accordance with the above method. An “Alarm Border” 704 may be color-coded to correspond to various alert-levels. A “Security Score Indicator” 706 that may be used to indicate the Security Threat Score of the node determined in accordance with the above method. The GUI element 700 also includes a “Selection Border” 708, a “Data Quality Indicator” 710, and “Data Value or State” 712.

### Interpretation.

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method for assessing a cybersecurity threat associated with a node in a network, the method comprising the steps of:
(a) storing in a memory, at least one rule for determining at least one cybersecurity threat score for the node, wherein each of the at least one rule is based on network information associated with the node comprising one or a combination of:
(i) a volume or a pattern of data packet traffic transmitted or received by the node;
(ii) a size, a content, or a communication protocol of a data packet transmitted to or received by the node;
(iii) a network address of the node;
(iv) a connection relationship of the node to another node in the network;
(v) an identifier or a role of a user of the node;
(vi) an identifier of the node; or
(vii) operational data indicative of an operational parameter of the node in a SCADA system;
(b) using a processor, monitoring the network to acquire the network information;
(c) using the processor, determining the at least one cybersecurity threat score for the node, based on the acquired network information and in accordance with the at least one rule; and
(d) using the processor, causing a display device to display the determined at least one cybersecurity threat score, a value derived from the determined at least one cybersecurity threat score, or an alert based on the determined at least one cybersecurity threat score.

2. The method of claim 1, wherein the network information comprises the volume or the pattern of data packet traffic transmitted or received by the node.

3. The method of any one of claims 1 to 2, wherein the network information comprises the size, the content, or the communication protocol of the data packet transmitted to or received by the node.

4. The method of any one of claims 1 to 3, wherein the network information comprises the network address of the node.

5. The method of any one of claims 1 to 4, wherein the network information comprises the connection relationship of the node to the another node in the network.

6. The method of any one of claims 1 to 5, wherein the network information comprises the identifier or the role of the user of the node.

7. The method of any one of claims 1 to 6, wherein the network information comprises the identifier of the node.

8. The method of any one of claims 1 to 7, wherein the network information comprises the operational data indicative of the operational parameter of the node in the SCADA system.

9. The method of any one of claims 1 to 8, wherein the node is a component of the SCADA system.

10. A system for assessing a cybersecurity threat associated with a node in a network, the system comprising: a processor; and a memory comprising a non-transitory computer-readable medium storing:
at least one rule for determining at least one cybersecurity threat score for the node, wherein each of the at least one rule is based on network information associated with the node comprising one or a combination of:
(i) a volume or a pattern of data packet traffic transmitted or received by the node;
(ii) a size, a content, or a communication protocol of a data packet transmitted to or received by the node:
(iii) a network address of the node;
(iv) a connection relationship of the node to another node in the network;
(v) an identifier or a role of a user of the node;
(vi) an identifier of the node: or
(vii) operational data indicative of an operational parameter of the node in a SCADA system; and
a set of instructions executable by the processor to perform a method comprising the steps of:
(a) monitoring the network to acquire the network information;
(b) determining values of the at least one cybersecurity threat score, based on the acquired network information and in accordance with the at least one rule; and
(c) causing a display device to display the determined at least one cybersecurity threat score, a value derived from the determined at least one cybersecurity threat score, or an alert based on the determined at least one cybersecurity threat score.

11. The system of claim 10, wherein the network information comprises the volume or the pattern of data packet traffic transmitted or received by the node.

12. The system of any one of claims 10 to 11, wherein the network information comprises the size, the content, or the communication protocol of the data packet transmitted to or received by the node.

13. The system of any one of claims 10 to 12, wherein the network information comprises the network address of the node.

14. The system of any one of claims 10 to 13, wherein the network information comprises the connection relationship of the node to the another node in the network.

15. The system of any one of claims 10 to 14, wherein the network information comprises the identifier or the role of the user of the node.

16. The system of any one of claims 10 to 15, wherein the network information comprises the identifier of the node.

17. The system of any one of claims 10 to 16, wherein the network information comprises the operational data indicative of the operational parameter of the node in the SCADA system.

18. The system of any one of claims 10 to 17, wherein the system comprises the node, wherein the node is a component of the SCADA system.

19. A method for controlling a response of a network to a data packet addressed from a first node having a first node location to a second node having a second node location in the network, the method comprising the steps of:
(a) using the processor, in accordance with at least one rule stored in a memory, determining an access control score based on the first node location and the second node location; and
(b) using the processor, controlling the response of the network comprising one or a combination of:
(i) either allowing or preventing transmission of the data packet to the second node, depending on the determined access control score;
(ii) varying a cybersecurity threat score for the second node based on the determined access control score; or
(iii) causing a display device to display the determined access control score, a value derived from the determined access control score, or an alert based on the determined access control score.

20. The method of claim 19, wherein the processor determines the first and second node locations from contents of the data packet.

21. The method of any one of claims 19 to 20, wherein the access control score is determined in accordance with the at least one rule based on whether the first and second node locations are within a same domain or a same zone of the network.

22. The method of any one of claims 19 to 21, wherein the access control score is determined in accordance with the at least one rule based on whether the first node location is external to the network.

23. The method of any one of claims 19 to 22, wherein the response comprises either allowing or preventing transmission of the data packet to the second node, depending on the determined access control score.

24. The method of claim 23, wherein the response comprises preventing transmission of the data pack to the second node.

25. The method of claim 24, wherein the response further comprises extracting data from the data packet and storing the data in a data buffer memory.

26. The method of claim 25, wherein the response further comprises storing a time stamp in the data buffer memory, wherein the time stamp is indicative of an attempted transmission time of the data packet form the first node to the second node.

27. The method of any one of claims 19 to 26, wherein the response comprises varying the cybersecurity threat score for the second node based on the determined access control score.

28. The method of any one of claims 19 to 27, wherein the response comprises causing the display device to display the determined access control score, the value derived from the determined access control score, or an alert based on the determined access control score.

29. The method of any one of claims 19 to 28, wherein the access control score is further based on a volume or a pattern of data packet traffic transmitted or received by the first node.

30. The method of any one of claims 19 to 29, wherein the access control score is further based on a size, a content, or a communication protocol of the data packet or another data packet transmitted to or received by the first node.

31. The method of any one of claims 19 to 30, wherein the access control score is further based on a network address of the first node.

32. The method of any one of claims 19 to 31, wherein the access control score is further based on a connection relationship of the first node to another node in the network.

33. The method of any one of claims 19 to 32, wherein the access control score is further based on an identifier or the role of an user of the first node.

34. The method of any one of claims 19 to 33, wherein the access control score is further based on an identifier of the first node.

35. The method of any one of claims 19 to 34, wherein the access control score is further based on operational data indicative of an operational parameter of the first node in the SCADA system.

36. The method of any one of claims 19 to 35, wherein the second node is a component of the SCADA system.

37. A system for controlling a response of a network to a data packet addressed from a first node having a first node location in the network to a second node having a second node location in the network, the system comprising: a processor and a memory comprising a non-transitory computer-readable medium storing a set of instructions executable by the processor to perform a method comprising the steps of:
(a) in accordance with at least one rule stored in the memory, determining an access control score based on the first node location and the second node location;
(b) controlling the response of the network comprising one of:
(i) either allowing or preventing transmission of the data packet to the second node, depending on the determined access control score;
(ii) varying a cybersecurity threat score for the second node, based on the determined access control score; or
(iii) causing a display device to display the determined access control score, a value derived from the determined access control score, or an alert based on the determined access control score.

38. The system of claim 37, wherein the processor determines the first and second node locations from contents of the data packet.

39. The system of any one of claims 37 to 37, wherein the access control score is determined in accordance with the at least one rule based on whether the first and second node locations are within a same domain or a same zone of the network.

40. The system of any one of claims 37 to 38, wherein the access control score is determined in accordance with the at least one rule based on whether the first node location is external to the network.

41. The system of any one of claims 37 to 39, wherein the response comprises either allowing or preventing transmission of the data packet to the second node, depending on the determined access control score.

42. The system of claim 40, wherein the response comprises preventing transmission of the data pack to the second node.

43. The system of claim 41, wherein the response further comprises extracting data from the data packet and storing the data in a data buffer memory.

44. The system of claim 42, wherein the response further comprises storing a time stamp in the data buffer memory, wherein the time stamp is indicative of an attempted transmission time of the data packet form the first node to the second node.

45. The system of any one of claims 37 to 44, wherein the response comprises varying the cybersecurity threat score for the second node, based on the determined access control score.

46. The system of any one of claims 37 to 45, wherein the response comprises causing the display device to display the determined access control score, the value derived from the determined access control score, or the alert based on the determined access control score.

47. The system of any one of claims 37 to 46, wherein the access control score is further based on a volume or a pattern of data packet traffic transmitted or received by the first node.

48. The system of any one of claims 37 to 47, wherein the access control score is further based on a size, a content, or a communication protocol of the data packet or another data packet transmitted to or received by the first node.

49. The system of any one of claims 37 to 48, wherein the access control score is further based on a network address of the first node.

50. The system of any one of claims 37 to 49, wherein the access control score is further based on a connection relationship of the first node to another node in the network.

51. The system of any one of claims 37 to 50, wherein the access control score is further based on an identifier or the role of an user of the first node.

52. The system of any one of claims 37 to 51, wherein the access control score is further based on an identifier of the first node.

53. The system of any one of claims 37 to 52, wherein the access control score is further based on operational data indicative of an operational parameter of the first node in a SCADA system.

54. The system of any one of claims 37 to 53, wherein the system comprises the second node, and wherein the second node is a component of a SCADA system.

55. A method for controlling a response of a network to a data packet addressed from a first node to a second node in the network, the method comprising the steps of:
(a) storing in a memory, a rule for determining a cybersecurity threat score for the first node, wherein the rule is based on network information associated with the node comprising one or a combination of:
(i) a volume or a pattern of data packet traffic transmitted or received by the first node;
(ii) a size, a content, or a communication protocol of the data packet or another data packet transmitted to or received by the first node:
(iii) a network address of the first node;
(iv) a connection relationship of the first node to another node in the network:
(v) an identifier or a role of a user of the first node;
(vi) an identifier of the first node: or
(vii) operational data indicative of an operational parameter of the first node in a SCADA system:
(b) using a processor, monitoring the network to acquire the network information;
(c) using the processor, determining the cybersecurity threat score for the first node, based on the acquired network information and in accordance with the rule; and
(d) using the processor, controlling the response of the network comprising one or a combination of:
(i) either allowing or preventing transmission of the data packet to the second node, depending on the determined cybersecurity threat score;
(ii) varying a cybersecurity threat score for the second node based on the determined cybersecurity threat score: or
(iii) causing a display device to display the determined cybersecurity threat score, a value derived from the determined cybersecurity threat score, or an alert based on the determined cybersecurity threat score.

56. The method of claim 55, wherein the network information comprises the volume or the pattern of data packet traffic transmitted or received by the first node.

57. The method of any one of claims 55 to 56, wherein the network information comprises the size, the content, or the communication protocol of the data packet or another data packet transmitted to or received by the first node.

58. The method of any one of claims 55 to 57, wherein the network information comprises the network address of the first node.

59. The method of any one of claims 55 to 58, wherein the network information comprises the connection relationship of the first node to the another node in the network.

60. The method of any one of claims 55 to 59, wherein the network information comprises the identifier or the role of a user of the first node.

61. The method of any one of claims 55 to 60, wherein the network information comprises the identifier of the first node.

62. The method of any one of claims 55 to 61, wherein the network information comprises the operational data indicative of the operational parameter of the first node in the SCADA system.

63. The method of any one of claims 55 to 62, wherein the first node is a component of a SCADA system.

64. The method of any one of claims 55 to 63, wherein the response comprises either allowing or preventing transmission of the data packet to the second node, depending on the determined cybersecurity threat score.

65. The method of claim 64, wherein the response comprises preventing transmission of the data pack to the second node.

66. The method of claim 65, wherein the response further comprises extracting data from the data packet and storing the data in a data buffer memory.

67. The method of claim 66, wherein the response further comprises storing a time stamp in the data buffer memory, wherein the time stamp is indicative of an attempted transmission time of the data packet form the first node to the second node.

68. The method of any one of claims 55 to 67, wherein the response comprises varying the cybersecurity threat score for the second node based on the determined cybersecurity threat score.

69. The method of any one of claims 55 to 68, wherein the response comprises causing the display device to display the determined cybersecurity threat score, the value derived from the determined cybersecurity threat score, or an alert based on the determined cybersecurity threat score.

70. A system for controlling a response of a network to a data packet addressed from a first node having a first to a second node in the network, the system comprising a processor, and a memory comprising a non-transitory computer-readable medium storing:
a rule for determining a cybersecurity threat score for the first node, wherein the rule is based on network information associated with the node comprising one or a combination of:
(i) a volume or a pattern of data packet traffic transmitted or received by the first node;
(ii) a size, a content, or a communication protocol of the data packet or another data packet transmitted to or received by the first node;
(iii) a network address of the first node;
(iv) a connection relationship of the first node to another node in the network;
(v) an identifier or a role of a user of the first node;
(vi) an identifier of the first node: or
(vii) operational data indicative of an operational parameter of the first node in a SCADA system; and
a set of instructions executable by the processor to perform a method comprising the steps of;
(a) monitoring the network to acquire the network information;
(b) determining the cybersecurity threat score for the first node, based on the acquired network information and in accordance with the rule; and
(c) controlling the response of the network comprising one or a combination of:
(i) either allowing or preventing transmission of the data packet to the second node, depending on the determined the cybersecurity threat score;
(ii) varying a cybersecurity threat score for the second node based on the determined cybersecurity threat score; or
(iii) causing a display device to display the determined cybersecurity threat score, a value derived from the determined cybersecurity threat score, or an alert based on the determined cybersecurity threat score.

71. The system of claim 70, wherein the network information comprises the volume or the pattern of data packet traffic transmitted or received by the first node.

72. The system of any one of claims 70 to 71, wherein the network information comprises the size, the content, or the communication protocol of the data packet transmitted or another data packet transmitted to or received by the first node.

73. The system of any one of claims 70 to 72, wherein the network information comprises the network address of the first node.

74. The system of any one of claims 70 to 73, wherein the network information comprises the connection relationship of the first node to the another node in the network.

75. The system of any one of claims 70 to 74, wherein the network information comprises the identifier or the role of the user of the first node.

76. The system of any one of claims 70 to 75, wherein the network information comprises the identifier of the first node.

77. The system of any one of claims 70 to 76, wherein the network information comprises the operational data indicative of the operational parameter of the first node in a SCADA system.

78. The system of any one of claims 70 to 77, wherein the system comprises the first node, wherein the first node is a component of a SCADA system.

79. The system of any one of claims 70 to 78, wherein the response comprises either allowing or preventing transmission of the data packet to the second node, depending on the determined cybersecurity threat score.

80. The system of claim 79, wherein the response comprises preventing transmission of the data pack to the second node.

81. The system of claim 80, wherein the response further comprises extracting data from the data packet and storing the data in a data buffer memory.

82. The system of claim 81, wherein the response further comprises storing a time stamp in the data buffer memory, wherein the time stamp is indicative of an attempted transmission time of the data packet form the first node to the second node.

83. The system of any one of claims 70 to 82, wherein the response comprises varying the cybersecurity threat score for the second node based on the determined cybersecurity threat score.

84. The system of any one of claims 70 to 83, wherein the response comprises causing the display device to display the determined cybersecurity threat score, the value derived from the determined cybersecurity threat score, or an alert based on the determined cybersecurity threat score.

85. A method for maintaining a network to reduce cybersecurity risks, the method performed by a processor and comprising the steps of:
(a) transmitting a first notification to a first node of the network to take a maintenance action for the network within a time period; and
(b) if the maintenance action is not taken within the time period, escalating the first notification, by transmitting a second notification to a second node of the network to take the maintenance action.

86. The method of claim 85, wherein the maintenance action comprises installation of software.

87. The method of any one of claims 85 to 86, wherein the maintenance action comprises storing data to a memory.

88. The method of any one of claims 85 to 87, wherein the maintenance action comprises removing or replacing a hardware or software component.

89. The method of any one of claims 85 to 88, wherein the first node and second node are components of a SCADA system.

90. A system for maintaining a network to reduce cybersecurity risks, the system comprising a processor, and a non-transitory computer-readable medium storing instructions executable by the processor to perform a method comprising the steps of:
(a) transmitting a first notification to a first node of the network to take a maintenance action for the network within a time period; and
(b) if the maintenance action is not taken within the time period, escalating the first notification, by transmitting a second notification to a second node of the network to take the maintenance action.

91. The system of claim 90, wherein the maintenance action comprises installation of software.

92. The system of any one of claims 90 to 91, wherein the maintenance action comprises storing data to a memory.

93. The system of any one of claims 90 to 92, wherein the maintenance action comprises removing or replacing a hardware or software component.

94. The system of any one of claims 90 to 93, wherein the system comprises the first node and the second node, and wherein the first node and second node are components of a SCADA system.
